(19) United States
(12) Patent Application Publication
(10) Pub. No.: US 2011/0177900 A1
(43) Pub. Date: Jul. 21, 2011

(54) HYBRID ELECTRIC VEHICLE DRIVE SYSTEM AND CONTROL SYSTEM FOR CONTROLLING A HYBRID ELECTRIC VEHICLE DRIVE SYSTEM

(75) Inventor: Bernard J. Simon, Troy, MI (US)

(73) Assignee: MEANS INDUSTRIES, INC., Saginaw, MI (US)

(21) Appl. No.: 12/964,792

(22) Filed: Dec. 10, 2010

Related U.S. Application Data
(60) Provisional application No. 61/295,420, filed on Jan. 15, 2010.

(51) Int. Cl. F16D 48/06; F16H 1/28

(52) U.S. Cl. 475/5; 180/65.275; 903/902

(57) ABSTRACT

A hybrid electric vehicle drive system and a control system for controlling a hybrid drive system are provided. The drive system includes a housing, an input shaft for inputting motive power from an internal combustion engine and an output shaft operatively linked to at least one drive wheel. The drive system also includes a first electric motor disposed within the housing and having a first rotor and a stator fixed to the housing and a second electric motor disposed within the housing and having a second rotor and a stator fixed to the housing. The drive system further includes gearing disposed within the housing and coupled to the second rotor to transmit revolutions of the second rotor to the output shaft. The drive system still further includes a planetary gear set disposed within the housing. The gear set includes a first rotary element coupled to the input shaft, a second rotary element coupled to the first rotor and a third rotary element coupled to the gearing. The gearing transmits revolutions of the third rotary element to the output shaft. The drive system also includes a controllable overrunning coupling assembly including a first coupling member fixed to the housing and a second coupling member coupled to the second rotary element and supported for rotation relative to the first coupling member in an overrun mode and coupled to the first coupling member in a locked mode. The second rotary element is locked to the housing in the locked mode of the coupling assembly.

### CROSS REFERENCE TO RELATED APPLICATION

This application claims the benefit of U.S. provisional patent Application Ser. No. 61/295,420 filed Jan. 15, 2010 and entitled “Single-Mode, Hybrid-Vehicle Power Train Including Controllable Or Selectable Overrunning Coupling Assembly And Method Of Controlling The Power Train”.

### TECHNICAL FIELD OF THE INVENTION

This invention relates to hybrid electric vehicle power trains or drive systems including controllable or selectable overrunning coupling assemblies and systems for controlling such drive systems and, in particular, to hybrid electric drive systems that have controllable one-way clutches (OWCs) to lock engine torque reaction elements to their cases (ground) in lieu of an electric motor(s) for improved highway fuel economy.

### Overview

Today's step ratio automatic transmissions use hydraulics to power the ratio change, dampen NVH, power coupling/decoupling, and providing lubrication and cooling. This is achieved with the use of a torque converter (for coupling/decoupling power, multiplying torque, and NVH dampening), an oil pump, valve body (or hydraulic logic), and friction-type clutches (bands and frictions which are activated by hydraulics to selectively lock and release components).

### Multi-Plate Friction-Type Clutches And Brakes

Clutches and brakes are used to drive or hold members of a planetary gear set, respectively. As a general rule, multi-plate clutches connect one planetary member to another. Multi-plate brakes connect a planetary member to the transmission case to hold it stationary.

The clutches and brakes consist of a number of friction discs and steel discs. The friction discs are coated with a friction material and have engaging lugs (splines) on the inner perimeter. The steel discs are steel on both sides and have engaging lugs located on the outer perimeter. The engaging lugs on the friction discs are usually engaged with a planetary member. The engaging lugs on the steel discs are usually engaged with the clutch piston housing.

In addition to the friction and steel discs, there is also an apply piston, housing and return spring. Once hydraulic fluid is applied to the clutch assembly, the piston advances and the friction and steel discs will be locked together. Once the hydraulic pressure is released, the return spring will cause the piston to return to its rest position and the friction and steel discs will be unlocked.

A band-type brake is used for some applications. The brake band is a circular band with friction material bonded to the inner surface. The band wraps around a particular planetary component (clutch drum) and locks that component to the transmission case. The brake band is applied and released by the clutch apply piston.

In order to carry out a shift in ratio, fluid needs to be applied or released from the multi-plate clutch (or brake). The following method occurs:

1. Fluid from a shift valve in the valve body is applied to the clutch assembly.

2. Fluid pressure builds behind the apply piston and overcomes the resistance from diaphragm spring.

3. The friction and steel discs are compressed together and become locked, preventing any slippage between them.

4. Two planetary members are now locked together.

5. When fluid pressure is released, the steel and friction discs are allowed to unlock.

This method has had some advantages. The power density is very high using hydraulics to clamp clutches and to multiply torque. Hydraulic systems have proven to have good dampening characteristics and smooth shift capability. It is also a natural way to lubricate the components in the transmission and to carry away heat from torque converters, pumps, gear sets, bearings, etc.

However, there are a few disadvantages. The first is efficiency. The pump is always on and pumping oil whenever the engine is running. When a friction element is turned on, power is used to maintain the clamping pressure of that friction element.

The slipping of the torque converter is also a significant source of parasitic loss and the open friction elements in the transmission provide drag and thus parasitic losses also. Another disadvantage is the complexity of these components. Clutches, pumps, torque converters, and valve bodies are among the most likely components within a transmission to have issues and thus drive warranty cost and negatively impact upon customer satisfaction. These components also tend to be the most expensive components in the transmission.

A one-way clutch (i.e., OWC) produces a drive connection (locked state) between rotating components when their relative rotation is in one direction, and overruns (freewheel state) when relative rotation is in the opposite direction. A typical one-way clutch consists of an inner ring, an outer ring and a locking device between the two rings. Two types of one-way clutches often used in vehicular, automatic transmissions include:
Roller type which consists of spring loaded rollers between the inner and outer race of the one-way clutch. (Roller type is also used without springs on some applications); and
Sprag type which consists of asymmetrically shaped wedges located between the inner and outer race of the one-way clutch.

The one-way clutches are typically used in the transmission to prevent an interruption of drive torque (i.e., power flow) during certain gear shifts and to allow engine braking during coasting. Also there is a one-way clutch in the stator of the torque converter.

A controllable OWC is a OWC where the lock action can be turned “off” such that it freewheels in both directions, and/or the lock action can be turned “on” such that it locks in one or both directions.

U.S. Pat. No. 5,927,455 discloses a bi-directional overrunning pawl-type clutch having a driving member mounted for power rotation, a driven member mounted for rotation adjacent the driving member, with each of the driving and driven members having pawl engaging shoulders, and a plurality of rigid pawls interposed between the driving and driven members. A control element is mounted for shifting movement between the driving and driven members to control the position of the pawls which are yieldably biased toward positions of engagement extending between the driving and driven members to produce driving engagement therebetween. The control element is shiftable to various positions to permit driving and overrunning in one direction or driving and overrunning in the opposite direction dependent upon the direction of rotation of the driving member.

U.S. Pat. No. 6,244,965 discloses a planar overrunning coupling for transfer of torque from a driving member to a driven member in one direction and which permits freewheeling motion between the members upon a torque reversal. The coupling includes coupling plates situated in close proximity with a strut retainer plate disposed between them, one plate being connected to the driving member and the other plate being connected to the driven member, each plate having strut recesses, a series of struts located in the recesses of one plate so that each strut may be pivoted, thereby allowing the struts to engage the companion recesses in the other coupling plate. The retainer has angularly spaced apertures that register with the struts to permit pivotal movement of the struts when the retainer plate is in one rotary position. The retainer plate, when it is in a second rotary position, prevents pivotal motion of the struts, thereby permitting freewheeling relative motion of the coupling plates.

U.S. Pat. No. 6,290,044 discloses a selectable one-way clutch assembly for use in an automatic transmission comprising a strut plate rotatable about a central hub and having pockets and struts mounted therein for pivotable rotation. A selecting plate concentrically located about an activator hub has teeth extending axially inboard and configured to fit in the apertures in an activator plate. A turning device is selectively operable to activate one-way clutching mode by rotating the pin of a control plate to disengage selecting cams and displace selecting plate teeth inboard beyond the inboard face of the activator plate wherein the struts catch the teeth when the strut plate assembly is rotated in a clutching direction. The catching ends of the struts are cammed in the pockets by ramped camming ends of the teeth when the strut plate assembly is rotated in the opposing direction, thereby allowing freewheeling of the strut plate in the overrun direction.

U.S. Pat. No. 7,258,214 discloses an overrunning coupling assembly and a method of controlling the engagement of planar first and second members wherein two sets of opposed engaging struts are applied with one motion of a single control plate or member. The planar first and second members have inside surfaces extending generally normal to a first axis. The assembly includes free-floating, forward keys and free-floating, reverse keys opposed to the forward keys. The forward and reverse keys are movable between a notch-engaging, engaged position and a disengaged position in which the second member is permitted to free-wheel relative to the first member. The planar control member is disposed between the first and second surfaces and is controllably rotatable about the first axis between first and second angular positions relative to the first member.

U.S. Pat. No. 7,344,010 discloses an overrunning coupling assembly and a method of controlling the engagement of planar first and second members wherein the assembly includes clustered pawls and their respective pawl-holding portions. The planar first and second members have inside surfaces extending generally normal to a first axis. The pawls include a forward set of free-floating pawls and a reverse set of free-floating, clustered pawls. The forward and reverse sets of pawls are movable between a notch-engaging, engaged position and a disengaged position. Because of the clustering, a control element, disposed between the first and second surfaces, need not be fully circular and is controllably rotatable about the first axis between first and second angular positions relative to the first member.

U.S. Pat. No. 7,484,605 discloses an overrunning radial coupling assembly or clutch and a method of controlling the engagement of inner and outer plates or members of the assembly wherein adjacent engaging radial locking pawls are selectively controlled by a single, rotatable control plate or element to obtain full lock, one-way lock and one-way overrun conditions. The assembly includes free-floating, forward pawls and free-floating, reverse pawls adjacent to their respective forward pawls. The forward and reverse pawls are movable between a notch-engaging, engaged position (i.e., full lock condition) and a disengaged position in which the outer member is permitted to free-wheel relative to the inner member in the one-way overrun condition in one direction about a first axis and the outer member is locked to the inner member in the one-way lock condition in the opposite direction. A number of different embodiments of the assembly and method are provided.

A properly designed controllable OWC can have near-zero parasitic losses in the “off” state. It can also be activated by electro-mechanics and does not have either the complexity or parasitic losses of a hydraulic pump and valves.

Other related U.S. patent publications include: 2010/0252384; 2010/0230226; 2010/0200358; 2009/0211863; 2009/0159391; 2009/0098970; 2008/0223681; 2008/0110715; 2008/0169166; 2008/0185253; 2007/0278061; 2007/0056825; 2006/0185957; and the following U.S. Pat. Nos. 7,464,801; 7,275,628; 7,198,587; 6,814,201; 6,193,038; 4,050,560; 5,638,929; 5,362,293; 5,678,668; and 5,918,715.

Referring to FIG. 1, a typical single-mode hybrid transmission or power train comprises an engine, two electric motors, a three-node planetary carrier, and a battery (not shown). The engine is connected to the center node of the planetary gear set, the first motor (Motor A) is connected to one end node, and both the output and second motor (Motor B) are connected to the other node. The arrangement used in the Toyota Prius has the engine connected to the carrier of a simple planetary gear set, the first motor is connected to the sun gear, and the second motor and ring gear are both connected to the output through a reduction gearing. The output is connected to a pair of vehicle axes via a differential gear unit. Wheels are attached to the respective vehicle axes. The coil of each of the motors is supported on the vehicle body. A control section or main controller includes motor and engine controllers.

U.S. patents assigned to Toyota and which describe such transmissions or power trains include: U.S. Pat. Nos. 5,847,469; 5,856,709; 6,019,699; 6,306,057; 6,344,008; 7,201,690; 7,223,200; 7,255,186; 7,393,296; 7,397,296; 7,426,971; 7,614,466; 7,621,359; and 7,690,455.

The hybrid power train of FIG. 1 allows for an infinitely variable speed ratio between the engine and the output. This allows the engine to be run at an optimal setting for maximum fuel economy. Engine speed is managed through Motor A as follows:

At low vehicle speeds, the engine can remain off. To keep the engine at zero-speed, Motor A increasingly counter rotates as output speed increases.

At a set speed, the engine is started by accelerating Motor A to the forward direction.

As the vehicle continues to accelerate, engine speed is managed into an efficient speed range by decelerating Motor A.

At highway speeds, Motor A is at near zero speeds and the transmission now acts in a similar fashion to a conventional overdrive gear set.

FIG. 2 shows graphs which are representative of the above-described hybrid operation.

Although the engine is always managed to an efficient operating point, there are parasitic losses associated with using Motor A as a holding clutch. Because of this, the highway fuel economy of single-mode hybrids is unexceptional and at some speeds can be worse than a conventional vehicle.

For purposes of this application, the term “coupling” should be interpreted to include clutches or brakes wherein one of the plates is drivably connected to a torque delivery element of a transmission and the other plate is drivably connected to another torque delivery element or is anchored and held stationary with respect to a transmission housing. The terms “coupling,” “clutch” and “brake” may be used interchangeably.

### SUMMARY OF EXAMPLE EMBODIMENTS

An object of at least one embodiment of the present invention is to provide an improved hybrid electric vehicle drive system including a controllable or selectable overrunning coupling assembly and a control system for controlling a hybrid electric vehicle drive system.

In carrying out the above object and other objects of at least one embodiment of the present invention, a hybrid electric vehicle drive system is provided. The system includes a housing, an input shaft for inputting motive power from an internal combustion engine and an output shaft operatively linked to at least one drive wheel. The system also includes a first electric motor disposed within the housing and having a first rotor and a stator fixed to the housing and a second electric motor disposed within the housing and having a second rotor and a stator fixed to the housing. The system further includes gearing disposed within the housing and coupled to the second rotor to transmit revolutions of the second rotor to the output shaft and a planetary gear set disposed within the housing. The gear set has a first rotary element coupled to the input shaft, a second rotary element coupled to the first rotor and a third rotary element coupled to the gearing. The gearing transmits revolutions of the third rotary element to the output shaft. The system still further includes a controllable overrunning coupling assembly having a first coupling member fixed to the housing and a second coupling member coupled to the second rotary element and supported for rotation relative to the first coupling member in an overrun mode and coupled to the first coupling member in a locked mode. The second rotary element is locked to the housing in the locked mode of the coupling assembly.

The gearing may be a reduction gearing.

The first rotary element may be a carrier gear, the second rotary element may be a sun gear, and the third rotary element may be a ring gear.

The planetary gear set may be a simple planetary gear set.

Further, in carrying out the above object and other objects of at least one embodiment of the present invention, a control system for controlling a hybrid electric vehicle drive system is provided. The drive system has a housing, an input shaft for inputting motive power from an internal combustion engine and an output shaft operatively linked to at least one drive wheel. The drive system also has a first electric motor disposed within the housing and with a first rotor and a stator fixed to the housing and a second electric motor disposed within the housing and with a second rotor and a stator fixed to the housing. The drive system also has gearing disposed within the housing and coupled to the second rotor to transmit revolutions of the second rotor to the output shaft, and a planetary gear set disposed within the housing. The gear set has a first rotary element coupled to the input shaft, a second rotary element coupled to the first rotor and a third rotary element coupled to the gearing. The gearing transmits revolutions of the third rotary element to the output shaft. The control system includes an overrunning coupling assembly including a first coupling member fixed to the housing and a second coupling member coupled to the second rotary element and supported for rotation relative to the first coupling member in an overrun mode and coupled to the first coupling member in a locked mode. The second rotary element is locked to the housing in the locked mode of the coupling assembly. The control system also includes a controller to control the coupling assembly to change between the locked mode and the overrun mode in response to a control signal.

The drive system may act as a conventional manual transmission with a fixed gear ratio in the locked mode of the coupling assembly.

The control system may further include a main controller. The main controller controls the controller of the coupling assembly and controls the first electrical motor. The first electric motor is de-powered in response to a control signal received from the main controller in the locked mode of the coupling assembly to eliminate parasitic losses associated with the first electric motor at a predetermined speed of the vehicle.

The above object and other objects, features, and advantages of at least one embodiment of the present invention are readily apparent from the following detailed description of the best mode for carrying out the invention when taken in connection with the accompanying drawings.

### BRIEF DESCRIPTION OF THE DRAWING FIGURES

FIG. 1 is a schematic view of a prior art single-mode, hybrid electric vehicle power train or transmission;

FIG. 2 are graphs of engine RPM and Motor A (or first motor) RPM versus vehicle speed for the power train of FIG. 1;

FIG. 3 is a schematic view of a single-mode, hybrid electric vehicle power train or drive system, as well as a control system constructed in accordance with at least one embodiment of the present invention; and

FIG. 4 are graphs of engine RPM and Motor A RPM versus vehicle speed for the power train or drive system of FIG. 3.

### DETAILED DESCRIPTION OF EXAMPLE EMBODIMENT(S)

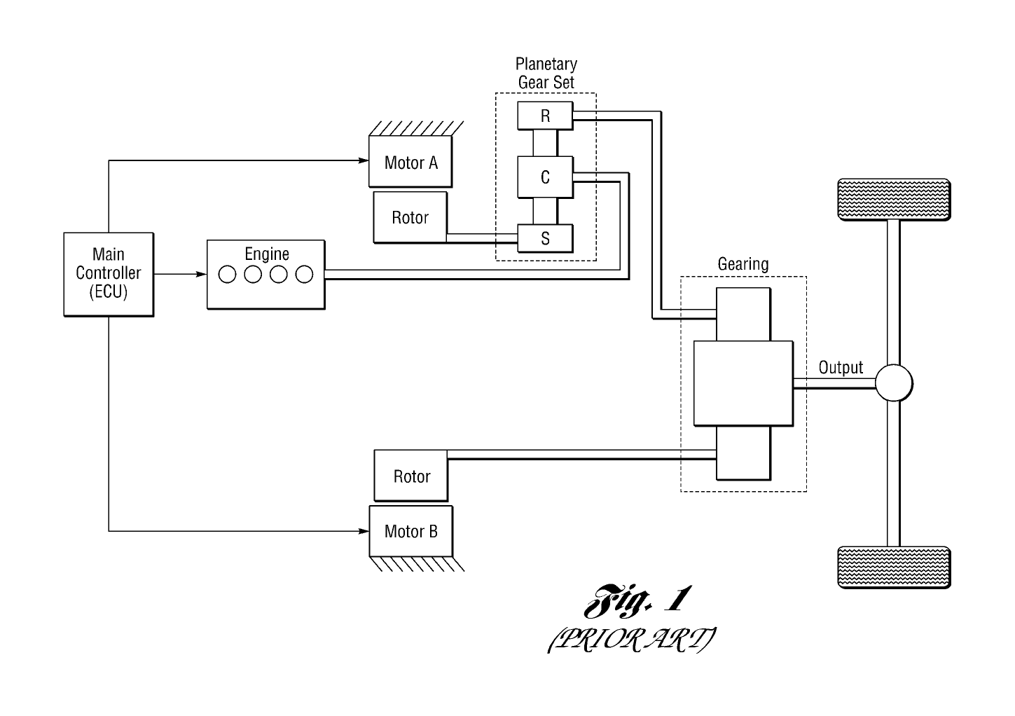

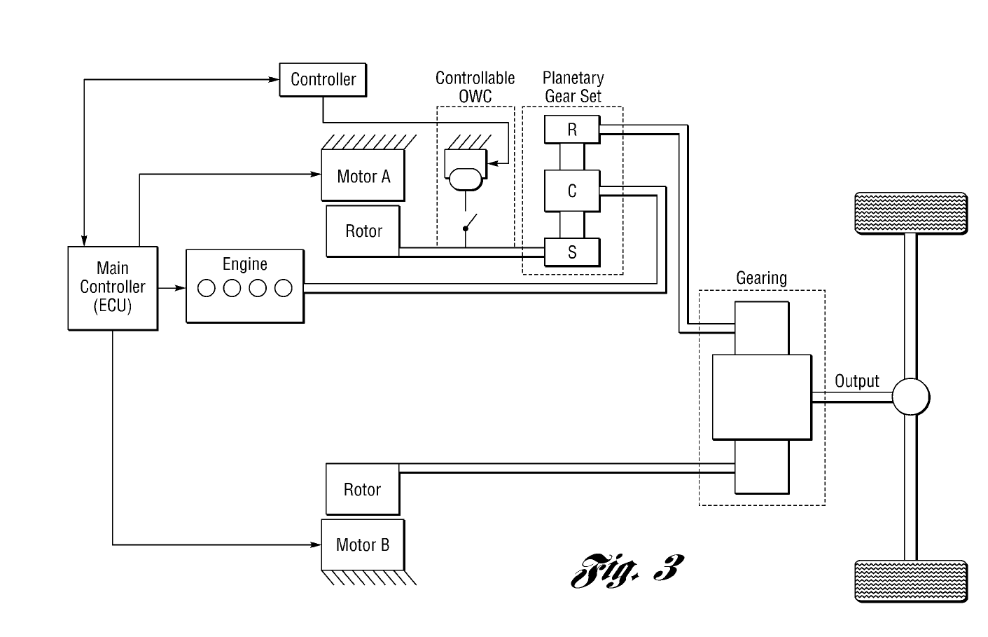

Referring now to FIG. 3, at least one embodiment of the invention is illustrated and shows a controllable OWC coupled to a first end node of a planetary gear set to create a mechanical connection between a sun gear (i.e., the first end node) and the case or housing of the drive system. The components of FIG. 3 are substantially identical to the components of FIG. 1 except for the controllable OWC and a controller coupled to the main controller for controlling the OWC. The controllable OWC is preferably generally of the type illustrated in the above-noted U.S. patents and published patent applications assigned to Means Industries, Inc. of Saginaw, Mich.

At least one embodiment of a hybrid electric vehicle drive system is illustrated in FIG. 3. The drive system includes: a housing, an input shaft for inputting motive power from an internal combustion engine and an output shaft operatively linked to at least one drive wheel. The drive system also includes a first electric motor (i.e., Motor A) disposed within the housing and having a first rotor and a stator fixed to the housing and a second electric motor (i.e., Motor B) disposed within the housing and including a second rotor and a stator fixed to the housing.

The drive system further includes gearing disposed within the housing and coupled to the second rotor to transmit revolutions of the second rotor to the output shaft and a planetary gear set disposed within the housing. The gear set has a first rotary element (C) coupled to the input shaft, a second rotary element (S) coupled to the first rotor and a third rotary element (R) coupled to the gearing. The gearing transmits revolutions of the third rotary element to the output shaft.

The drive system further includes a controllable overrunning coupling assembly (OWC) including a first coupling member fixed to the housing and a second coupling member coupled to the second rotary element and supported for rotation relative to the first coupling member in an overrun mode and coupled to the first coupling member in a locked mode. The second rotary element is locked to the housing in the locked mode of the OWC.

A controller controls the coupling assembly to change between its locked mode and the overrun mode in response to a control signal. The drive system of FIG. 3 acts as a conventional manual transmission with a fixed gear ratio in the locked mode of the coupling assembly.

The control system further includes a main controller. The main controller controls the controller of the coupling assembly and controls the first electric motor. The first electric motor is de-powered in response to a control signal received from the main controller in the locked mode of the coupling assembly to eliminate parasitic losses associated with the first electric motor at a predetermined speed of the vehicle as illustrated in FIG. 4.

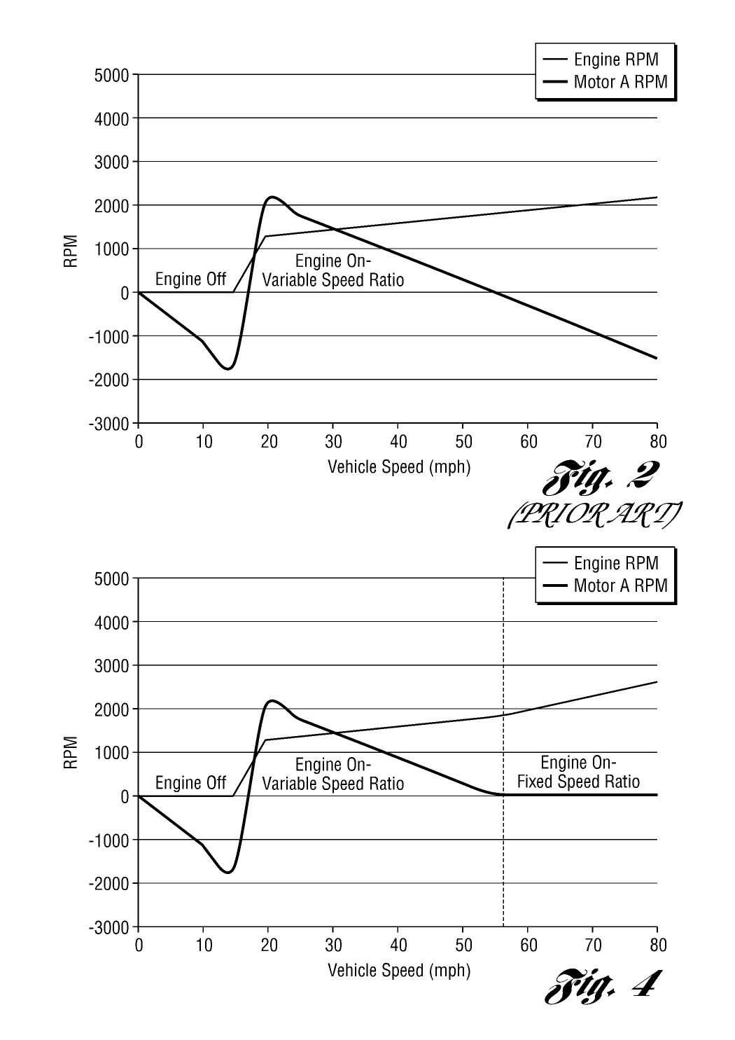

Comparing and contrasting FIG. 4 with FIG. 2, at low and moderate speeds, the hybrid electric power train or drive system of FIG. 3 would operate as before. At highway speeds, the OWC is activated and Motor A de-powered, eliminating the parasitic losses associated with it. The power train would then act as a conventional manual transmission with a fixed gear ratio. Although the engine would no longer be managed to an optimal speed, the loss of efficiency in the engine would be more than offset by the gain due to the reduction of parasitic (electrical) losses, and overall highway fuel economy will be improved.

A dual-mode hybrid configuration may be obtained by including a second controllable overrunning coupling assembly and a third electric motor (as may be embodied as an electric pump) resulting in a 3-motor hybrid.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A hybrid electric vehicle drive system comprising:
a housing;
an input shaft for inputting motive power from an internal combustion engine;
an output shaft operatively linked to at least one drive wheel;
a first electric motor disposed within the housing and including a first rotor and a stator fixed to the housing;
a second electric motor disposed within the housing and including a second rotor and a stator fixed to the housing;
gearing disposed within the housing and coupled to the second rotor to transmit revolutions of the second rotor to the output shaft;
a planetary gear set disposed within the housing and including a first rotary element coupled to the input shaft, a second rotary element coupled to the first rotor and a third rotary element coupled to the gearing, the gearing transmitting revolutions of the third rotary element to the output shaft; and
a controllable overrunning coupling assembly including a first coupling member fixed to the housing and a second coupling member coupled to the second rotary element and supported for rotation relative to the first coupling member in an overrun mode and coupled to the first coupling member in a locked mode wherein the second rotary element is locked to the housing in the locked mode of the coupling assembly.

2. The system as claimed in claim 1, wherein the gearing is a reduction gearing.

3. The system as claimed in claim 1, wherein the first rotary element is a carrier gear, the second rotary element is a sun gear, and the third rotary element is a ring gear.

4. The system as claimed in claim 1, wherein the planetary gear set is a simple planetary gear set.

5. A control system for controlling a hybrid electric vehicle drive system having: a housing, an input shaft for inputting motive power from an internal combustion engine, an output shaft operatively linked to at least one drive wheel, a first electric motor disposed within the housing and including a first rotor and a stator fixed to the housing, a second electric motor disposed within the housing and including a second rotor and a stator fixed to the housing, gearing disposed within the housing and coupled to the second rotor to transmit revolutions of the second rotor to the output shaft, and a planetary gear set disposed within the housing and including a first rotary element coupled to the input shaft, a second rotary element coupled to the first rotor and a third rotary element coupled to the gearing, the gearing transmitting revolutions of the third rotary element to the output shaft, the control system comprising:
an overrunning coupling assembly including a first coupling member fixed to the housing and a second coupling member coupled to the second rotary element and supported for rotation relative to the first coupling member in an overrun mode and coupled to the first coupling member in a locked mode wherein the second rotary element is locked to the housing in the locked mode of the coupling assembly; and
a controller to control the coupling assembly to change between the locked mode and the overrun mode in response to a control signal.

6. The control system as claimed in claim 5, wherein the gearing is a reduction gearing.

7. The control system as claimed in claim 5, wherein the first rotary element is a carrier gear, the second rotary element is a sun gear, and the third rotary element is a ring gear.

8. The control system as claimed in claim 5, wherein the planetary gear set is a simple planetary gear set.

9. The control system as claimed in claim 5, wherein the drive system acts as a conventional manual transmission with a fixed gear ratio in the locked mode of the coupling assembly.

10. The control system as claimed in claim 5, further comprising a main controller, the main controller controlling the controller of the coupling assembly and controlling the first electric motor wherein the first electric motor is de-powered in response to a control signal received from the main controller in the locked mode of the coupling assembly to eliminate parasitic losses associated with the first electric motor at a predetermined speed of the vehicle.
